(19) United States
(12) Patent Application Publication
(10) Pub. No.: US 2015/0219512 A1
(43) Pub. Date: Aug. 6, 2015

(54) METHOD OF AND SYSTEM FOR CALCULATION AND CONSOLIDATION OF FLIGHT PARAMETERS OF AN AIRCRAFT

(71) Applicant: ALENIA AERMACCHI S.p.A., ROMA (IT)

(72) Inventor: Danilo Bruti, Condove (IT)

(21) Appl. No.: 14/425,174

(22) PCT Filed: Sep. 5, 2013
(86) PCT No.: PCT/IB2013/058320

§ 371 Date: Mar. 2, 2015

(30) Foreign Application Priority Data
Sep. 5, 2012 (IT) TO2012A000770

(51) Int. Cl. G01L 13/00; G01P 3/00; B64D 45/00

(52) U.S. Cl. CPC G01L 13/00; B64D 45/00; G01P 3/00

(57) ABSTRACT

A method and system for calculation and consolidation of a first plurality of aircraft flight parameters including a second plurality of pressure sensors is provided. The pressure sensors are arranged in respective aircraft locations; each pressure sensor provides a pressure value based on a respective detected static pressure value. The method comprises: acquiring the pressure values from the pressure sensors; defining an equation system by associating with each pressure value a respective non-linear mathematical model describing the aerodynamic aircraft behaviour at the pressure sensor location, each respective mathematical model being a flight parameter function; iteratively solving the equation system, obtaining a current value of each of said flight parameters; calculating a plurality of intermediate pressure values by applying the current flight parameter values to each mathematical model; comparing each pressure value with the respective intermediate pressure value, obtaining a result value; and detecting an operation state of the pressure sensors.

### TECHNICAL FIELD

The present disclosure relates to a method and system of calculation and consolidation of flight parameters of an aircraft.

### BACKGROUND ART

Almost all operating aircraft, both civil and military, use sensors that protrude from the surfaces of the aircraft, in particular floating fins for measuring incidence and sideslip angles. The sensors are able to directly measure quantities such as flow angles and local velocities and, in general, flight parameters useful for determining the aircraft's attitude, altitude and flight speed. The algorithms used for processing the data measured by these sensors, as well as their peculiarities tied to the location of the sensors on the aircraft, their characteristics and the system reliability/redundancy requirements, are developed for virtually the sole purpose of measurement calibration.

Static pressure sensors of the type available on the market, for example pressure sensors made using MEMS technology, have the advantage of small size and weight and do not protrude from the surface on which they are mounted. The use of such pressure sensors is therefore desirable. However, to obtain one or more of the above-mentioned flight parameters starting from static pressure measurements, complex algorithms are needed, which require considerable calculating capacity. Known algorithms for the calculation of flight parameters starting from static pressure measurements are typically based on using artificial intelligence and neural networks and guarantee functionality for calculation of the flight parameters and detection of any failures in the pressure sensors.

Document GB2432914 relates generally to air data sensing systems, such as flush air data systems (FADS), for use on an air vehicle for providing fault isolation in artificial intelligence based air data sensing systems, such as neural network based FADS.

Document US 2011/238373 relates to in-flight calibration of aircraft pitot-static systems by modeling pressure error as a continuous function of airspeed. Measurements of static and differential pressure and Global Positioning System (GPS)-based ground speed measurements are utilized for computing pressure errors over a range of airspeed.

Document U.S. Pat. No. 5,423,209 relates to a truncated pyramid-shape multi-hole Pitot probe and a flight velocity detection system using the truncated pyramid-shape multi-hole Pitot probe.

Document EP2434296 relates generally to sensor systems and more specifically to airspeed sensor systems.

Document US 2004/011124 pertains to a process for determining aerodynamic parameters and to a process for detecting a fault with a probe used to determine the aerodynamic parameters of the airflow surrounding an aircraft.

However, solutions of known type have the drawback of requiring a high calculating capacity (with consequent energy consumption) and, if a failure of one or more pressure sensors is detected, do not allow the exclusion of this/these sensor(s). In practice, these solutions of known type “live” with the failure. The information coming from faulty sensors is still used in the calculation of the flight parameters.

### DISCLOSURE OF INVENTION

The object of the present disclosure is to provide a method and system of calculation and consolidation of flight parameters of an aircraft that overcome the drawbacks of the known art.

According to the present disclosure, a method and system of calculation and consolidation of flight parameters of an aircraft are provided as defined in the appended claims.

### BRIEF DESCRIPTION OF THE DRAWINGS

For a better understanding of the present disclosure, some preferred embodiments will now be described, purely by way of a non-limitative example, with reference to the attached drawings, where:

FIGS. 1a and 1b show views from above and below of an aircraft equipped with static pressure sensors at a plurality of locations; and

FIG. 2 shows, by means of a flowchart, a method of calculation and validation of flight parameters according to one embodiment of the present disclosure.

### BEST MODE FOR CARRYING OUT THE INVENTION

The method according to the present disclosure combines improved flight parameter calculation functionality with functionality for identifying and isolating malfunctioning sensors.

In particular, the method according to the present disclosure is based on the use of mathematical and physical models that bind the flight parameters to be calculated (or, more in general, state variables) to parameters measured in flight (local static pressures). The use of these models enables easier validation of the entire process with respect to the known art, with positive repercussions in terms of traceability and verification in a certification procedure.

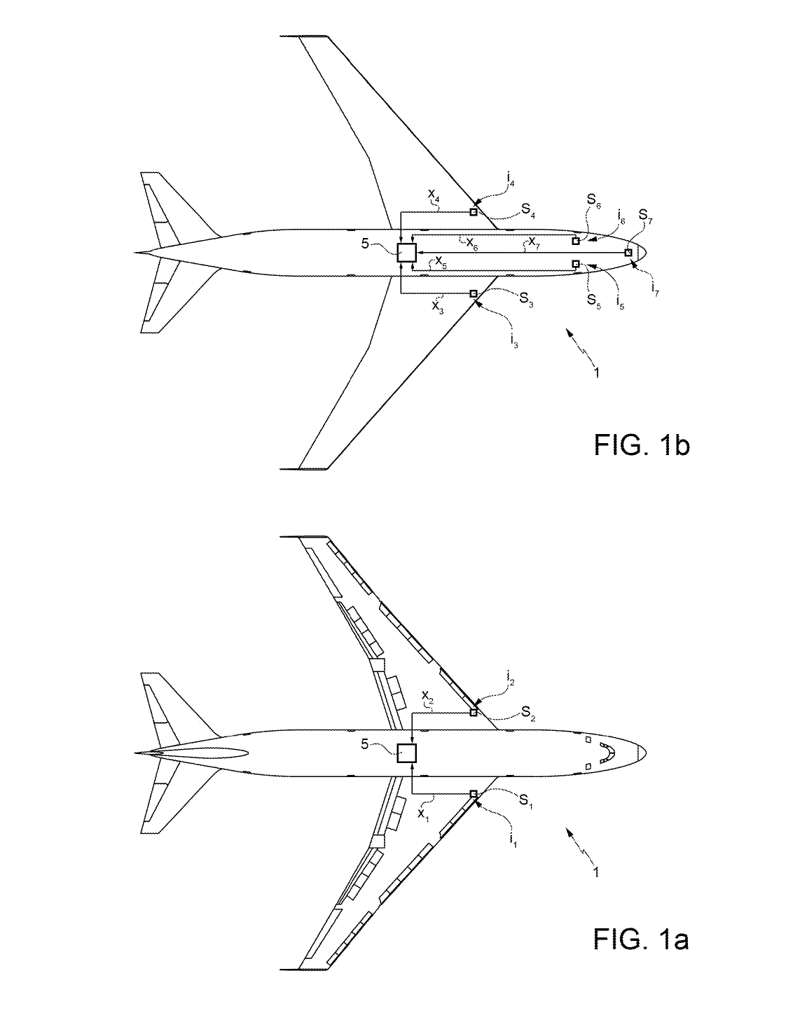

The local static pressure measurements are obtained by using a plurality N of pressure sensors S₁-S_{N}, of known type and available on the market, positioned in a plurality of respective locations on an aircraft. The pressure sensors can be of any type and made using any manufacturing technology (for example, MEMS technology), provided that they can be “buried” in the body of the aircraft in FIGS. 1a and 1b, in the sense that they do not significantly protrude from the surface of the aircraft's body. For example, such sensors do not significantly protrude when they do not constitute a radar signature element.

FIGS. 1a and 1b show an aircraft 1 by way of example, seen respectively from above and below, and comprising a plurality N of pressure sensors S₁-S_{N} with each one arranged at a respective location i₁-i_{N} on the aircraft 1 and possible housed in a respective casing able to protect each respective sensor from the external environment. In particular, each sensor S₁-S_{N} is integrated into the body of the aircraft 1 such that it is substantially coplanar with the body of the aircraft 1 at the location i₁-i_{N} in which it is positioned, or arranged within the body of the aircraft 1. In general, the sensors S₁-S_{N}, or in any case the casings that house a respective sensor S₁-S_{N}, do not protrude from the surface of the body of the aircraft 1 at the locations i₁-i_{N} where they are positioned. In order to allow the sensors S₁-S_{N} to correctly acquire static pressure information, the body of the aircraft 1 has one or more holes (not shown) at each location i₁-i_{N} that form the only interface of the pressure sensors S₁-S_{N} with the outside of the aircraft 1. The use of sensors integrated in the body of the aircraft 1 ensures a low contribution of the sensors S₁-S_{N} to the radar signature of the aircraft 1.

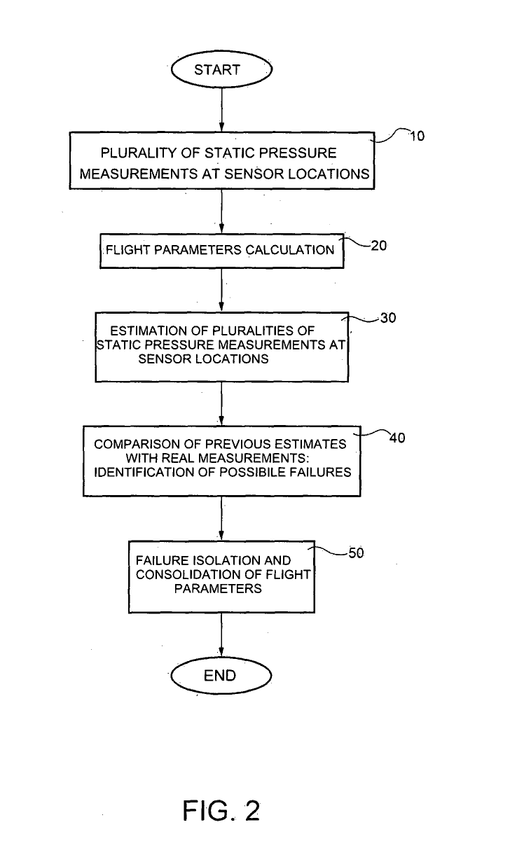

As mentioned, in use, each sensor S₁-S_{N} detects a static pressure value at location i₁-i_{N}, and generates a transduced signal X₁-X_{N} indicative of the static pressure value measured at a given moment in time (or, alternatively, an average value over a predetermined period of time). The transduced signal X₁-X_{N} is, in particular, an electrical signal, suitable for being received and processed by a computer 5, placed on board the aircraft 1. The computer 5 is further configured to implement a calculation algorithm of the type shown in the flowchart in FIG. 2.

The number of sensors S₁-S_{N} is chosen so as to comply with the system's redundancy and reliability requirements and therefore so as to support a number of failures of single sensors S₁-S_{N} without compromising the calculating capacity of the flight parameters, keeping their accuracy within a required limit (depending, for example, on the required aircraft-level specifications, as provided by the aircraft's designer to ensure controllability of the aircraft, and/or on the basis of any national legislations. The static pressure information of a single sensor S₁-S_{N} actually weighs on the calculated value of the flight parameters differently according to the total number N of sensors S₁-S_{N}: the larger the total number N of sensors S₁-S_{N}, the smaller this weight. The applicant has established that an ideal number N of sensors S₁-S_{N} (in terms of accuracy of calculated flight parameter values and resilience to possible failures) is 9. In general, it is preferable to have N≧7. Nevertheless, it is clear that it is possible to calculate flight parameters according to the present disclosure also using a number N of sensors S₁-S_{N} less than 7, accepting a drop in the accuracy of the calculated flight parameters values and a reduced ability to compensate for the possible failure of one or more sensors S₁-S_{N}.

The choice of the locations i₁-i_{N} for the sensors S₁-S_{N} on aircraft 1 is guided by the need to maximize the sensitivity of the acquired pressure values to variations in the flight parameters during the flight of the aircraft 1. Assessments for defining the “best” locations can be carried out, for example, by using computer simulators.

The applicant has established that the areas where changes in pressure corresponding to variations in the flight parameters (i.e. the gradients) are greatest (absolute values intended) are locations i₁-i_{N} shown in FIGS. 1a and 1b.

FIG. 2 shows, by means of a flowchart, the steps a method of calculation of flight parameters starting from the pressure measurements taken by the sensors S₁-S_{N}. The mathematical model for calculation of the flight parameters is developed from the aerodynamic mathematical model, in particular the aerodynamic model in the following equation (1):

$${P}_{loci} ( AOA , AOS , Mach ) = {Ps}_{∞} + {Cp}_{i} ( AOA , AOS , Mach ) * \frac{1}{2} γ {Ps}_{∞} {Mach}^{2} \qquad ( 1 )$$

where P_{loci} is the local static pressure measured by a sensor S₁-S_{N} at the respective location i₁-i_{N}, AOA is the angle of attack (sometimes called the angle of incidence) and indicated by letter α, AOS is the angle of sideslip and indicated by letter β, Mach represents the flight Mach number, Ps_{∞} is the flight static pressure, Cpᵢ is the pressure coefficient related to the location i₁-i_{N} considered, and γ is the ratio between specific heat at constant pressure and the specific heat at constant volume and is a constant having a value, for air, of between 1.3 and 1.5, in particular approximately 1.4 in the operating temperature range (between −40 and +40° C.).

The pressure coefficient Cpᵢ represents the link between the flight parameters to be calculated (state variables, Ps_{∞}, AOA, AOS and Mach) and the local static pressures P_{loci} measured in flight (dependent on the flight parameters AOA, AOS and Mach).

The values of the pressure coefficient Cpᵢ at the various locations i₁-i_{N} is obtained by using computer simulators and/or experimental testing in wind tunnels. The thus-obtained values for the pressure coefficient Cpᵢ are then tabulated in matrix form.

In greater detail, with regards to an experimental approach, construction of the arrays of Cpᵢ values is achieved as specified in steps a-f below:

a. A Mach value is set;
b. An angle of sideslip AOS value of zero is set;
c. The value of the angle of attack AOA is varied in predetermined steps, generally between 0.5 degrees and 1.0 degree; a Cpᵢ value is obtained for each pair of values (AOS; AOA);
d. Step c is repeated, setting a non-zero value for the angle of sideslip AOS; in particular, the repetition of step c must be carried out the same number of times as the values of angle of sideslip AOS for which it is intended to collect Cpᵢ values. In general, for AOS, values between 0 degrees and 10 degrees with a 2-degree step, both positive and negative, are selected;
e. For each pair of values (AOS; AOA), a Cpᵢ value is acquired on the basis of the previous step;
f. Steps b-e are repeated, setting a Mach value different from the value set in step a; in particular the repetition of steps b-f must be carried out the same number of times as the values of Mach for which it is intended to collect Cpᵢ values. In general, Mach values between 0.2 and the maximum envisaged by requirements are selected, with a variable step and preferably closer together near to the maximum (for example, a step of 0.1). At low Mach speeds, a step of 0.2 is adequate. In this way, for each Mach value considered, it is possible to build a table (or array) M containing a plurality of pressure coefficient Cpᵢ values for each pair of values (AOS; AOA) considered. Considering P flight Mach values, P arrays M₁-M_{P} are thus created.

Characterizing equation (1) for each pressure sensor S₁-S_{N} present on the aircraft 1, gives a system of non-linear equations, in which the subscript “i” takes i values from 1 to N:

P_{loci}=Fᵢ(Ps_{∞},Mach,AOA,AOS) (2)

where the P_{loci} variables constitute the known terms (measured by the sensors S₁-S_{N}) and Ps_{∞}, AOA, AOS and Mach are the flight parameters to be calculated, which constitute the unknown terms of a system of equations as better expressed hereinafter. The function Fᵢ in equation (2) is the aerodynamic model as per equation (1).

The main characteristic of this system of equations is non-linearity, already present in the aerodynamic model, made explicit by the square of the Mach number (Mach²) and contained in the relation, defined in points and described by the arrays M₁-M_{P}, which bind the pressure coefficients Cpᵢ and the flight parameters (Ps_{∞}, AOA, AOS and Mach).

Therefore, the resolution of the system of equations according to step 20 in FIG. 2 is interactively driven, starting from the consolidated solution at the previous time of calculation (initial condition) and performing linearization of the system. The iteration is implemented by making the system linear around the solution of the previous iteration and then calculating the variation of the state variables (in this case, the flight parameters Ps_{∞}, AOA, AOS and Mach). The Newton-Raphson method, known in the literature, is used for this purpose.

For a single sensor S₁-S_{N}, placed at the respective location i₁-i_{N}, the pressure variation with respect to the previous time can be written in the manner defined by the following equation (3):

$$δ {P}_{loci} = \frac{\partial {F}_{i}}{\partial {P}_{∞}} δ {Ps}_{∞} + \frac{\partial {F}_{i}}{\partial AOA} δ AOA + \frac{\partial {F}_{i}}{\partial AOS} δ AOS + \frac{\partial {F}_{i}}{\partial Mach} δ Mach + o ( δ {VAR}_{j}^{2} ) \qquad ( 3 )$$

where subscript “i” identifies each location i₁-i_{N}, and where VAR is the following vector:

VAR=[Ps_{∞}Mach,AOA,AOS] (4)

where j is the index of the locations of vector VAR (i.e., for j=1, one has VAR₁=Ps_{∞}; for j=2, one has VAR₂=Mach; for j=3, one has VAR₃=AOA; for j=4, one has VAR₄=AOS).

By defining array J as the gradient of array F ([J]=[∇F]), the notation of equation (3) can be simplified as follows:

$$δ {P}_{loci} = {\sum }_{j} {J}_{ij} δ {VAR}_{j} + o ( δ {VAR}_{j}^{2} ) \qquad ( 5 )$$

It should be noted that quantities preceded by the symbol “δ” represent the perturbations with respect to values/quantities defined at the previous time of calculation. As already mentioned, the initial condition of each calculation cycle is set equal to the solution calculated at the time of the previous calculation. Backtracking, it is necessary to initialize the calculation the very first time, as there is obviously no previously calculated solution. The initialization is carried out using predetermined values, for example the values regarding the aircraft 1 when stationary (on the ground).

Ignoring terms above the first order (i.e. performing a linearization operation) and considering equation (3) or, equivalently, equation (4), written for all the sensors and in matrix notation, it is possible to represent the system of equations (4) in the following manner:

$$[ \begin{matrix}δ {P}_{loc 1} \\ … \\ δ {P}_{loc N}\end{matrix} ] = [ J ] \cdot [ \begin{matrix}δ {Ps}_{∞} \\ δ AOS \\ δ AOA \\ δ Mach\end{matrix} ] \qquad ( 6 )$$

where the number of rows represents the number of information items (signals X₁-X_{N}) or, equivalently, the sensors S₁-S_{N} (used for calculation of the flight parameters) and the number of columns represents the number of unknown parameters (the actual flight parameters).

Therefore, defining the flight parameters that must be calculated in the current iteration as Ps_{∞}, AOA_{NEW}, AOS_{NEW} and Mach_{NEW}, and those regarding the previous iteration (or the initialization parameters at the first iteration) as Ps_{∞OLD}, AOA_{OLD}, AOS_{OLD} and Mach_{OLD}, gives:

$$[ \begin{matrix}{Ps}_{∞ NEW} \\ {Mach}_{NEW} \\ {AOA}_{NEW} \\ {AOS}_{NEW}\end{matrix} ] = [ \begin{matrix}{Ps}_{∞ OLD} \\ {Mach}_{OLD} \\ {AOA}_{OLD} \\ {AOS}_{OLD}\end{matrix} ] + [ \begin{matrix}δ {Ps}_{∞} \\ δ Mach \\ δ AOA \\ δ AOS\end{matrix} ] \qquad ( 7 )$$

Formula (7) is solved iteratively until a consolidated solution is reached, as described hereinafter.

Starting from formula (7), the state variables vector updated during the iterations (the one with the “NEW” suffix) is obtained by inverting array J as shown in the following formula (8):

$$[ \begin{matrix}{Ps}_{∞ NEW} \\ {Mach}_{NEW} \\ {AOA}_{NEW} \\ {AOS}_{NEW}\end{matrix} ] = [ \begin{matrix}{Ps}_{∞ OLD} \\ {Mach}_{OLD} \\ {AOA}_{OLD} \\ {AOS}_{OLD}\end{matrix} ] + {[ J ]}^{- 1} [ \begin{matrix}δ {P}_{loc 1} \\ … \\ δ {P}_{loc N}\end{matrix} ] \qquad ( 8 )$$

For an overdetermined system (number of known parameters greater than those unknown), the inversion of array J is carried out by applying the linear or ordinary least squares method:

$$[ \begin{matrix}{Ps}_{∞ NEW} \\ {Mach}_{NEW} \\ {AOA}_{NEW} \\ {AOS}_{NEW}\end{matrix} ] = [ \begin{matrix}{Ps}_{∞ OLD} \\ {Mach}_{OLD} \\ {AOA}_{OLD} \\ {AOS}_{OLD}\end{matrix} ] + {[ ( {∇}^{T} F ) ( ∇ F ) ]}^{- 1} {∇}^{T} F [ \begin{matrix}δ {P}_{loc 1} \\ … \\ δ {P}_{loc N}\end{matrix} ] \qquad ( 9 )$$

where [(∇^{T}F)(∇F)]⁻¹∇^{T}F analytically represents the operation of inverting array J. This gives:

[J]⁻¹=[[J]^{T}[J]]⁻¹[J]^{T}=[(∇^{T}F)(∇F)]⁻¹∇^{T}F.

For each iteration, array J is calculated again using the CPᵢ values stored in the P arrays M₁-M_{P}, starting from the values of the flight parameters calculated in the previous iteration (those with the “OLD” suffix). In other words, on the basis of the Mach, AOS and AOA values calculated in the previous iteration, for each location i₁-i_{N}, a corresponding value of Cpᵢ is obtained from arrays M₁-M_{P}; then, using the thus-obtained value of Cpᵢ together with the pressure value Ps_{∞OLD} in the “F” formula (equation (1)), it is possible to perform the operation described by formula (9). As already mentioned, these step are performed for each location i₁-i_{N}, or, in other words, for each sensor S₁-S_{N}.

As mentioned above, on the first iteration, when current values of the flight parameters Ps_{∞OLD}, AOA_{OLD}, AOS_{OLD} and Mach_{OLD}, do not exist, the latter are considered having their ground value, with the aircraft stationary, prior to take-off. Otherwise, the values of Ps_{∞OLD}, AOA_{OLD}, AOS_{OLD}, and Mach_{OLD} used are the last values calculated (and stored) during the iterations.

The convergence of the iterative calculation is evaluated by comparing the variation of the calculated flight parameters between two successive iterations and a predetermined tolerance Th: when the variation of these parameters is below the established tolerance Th, the iterative calculation has satisfied the convergence criterion. Instead, if the criterion is not satisfied, a new iteration is carried out using the updated state variables vector as the initial condition of the new iteration.

The use of iterative algorithms makes the introduction of convergence control criteria important, these having the purpose of ensuring that it is always possible to obtain a solution for each instance of calculation.

Therefore, in step 30 in FIG. 2, an estimate is made of the plurality of static pressure measurements at the locations i₁-i_{N} of the sensors S₁-S_{N}.

Once convergence of the iterative resolution process is achieved, the flight parameters calculated in step 20 are then used to provide an estimate of the static pressure values at the locations i₁-i_{N} by means of the aerodynamic model defined by equation (1). In practice, by inserting the values of the flight parameters Ps_{∞}, AOA, AOS and Mach calculated in step 20 into equation (1), an estimated pressure value Y₁-Y_{N} for each sensor S₁-S_{N} is obtained.

The comparison between these estimates Y₁-Y_{N} and the value X₁-X_{N} effectively measured at the locations i₁-i_{N} provides an indication of the quality of the solution found: the difference (or residual) between the estimated pressure values and the measured ones (X₁−Y₁, . . . , X_{N}−Y_{N}) represents the calculation error or level of approximation of the flight parameters with respect to their “real” values.

The comparison in step 30 enables, step 40, identifying possible failures of one or more sensors S₁-S_{N}.

In fact, on the basis of the definition of “residual” (i.e., X₁−Y₁, . . . , X_{N}−Y_{N}) provided in the previous paragraph, the functionality of identifying the failure of a single sensor S₁-S_{N} is obtained through the statistical analysis of these residuals, in particular by calculating the standard deviation of the residuals. To render the process of identifying individual failures effective and resilient, the residuals are calculated, as well as starting from the consolidated solution by using all “N” sensors S₁-S_{N} of the system, also from those obtained by the use of sensor subgroups. Each subgroup is constituted by all of the pressure sensors S₁-S_{N} less one. With this logical approach, it is possible to identify a number “N” of mutually different subgroups, each composed of N-i sensors. By calculating a value of standard deviation of the residuals for each subgroup, it is possible to compare the values of standard deviation associated with each subgroup with one other. Failure identification is achieved by comparing these values of standard deviation with each another.

The standard value associated with the subgroup that excludes the faulty sensor (i.e. that provides local static pressure values not consistent with those of the other locations) is significantly smaller than those of the other subgroups. By defining one or more thresholds, the pressure sensor missing from the subgroup having a standard value significantly smaller than those of the other subgroups is the pressure sensor that has failed.

This monitoring of residuals enables identifying possible failure of a sensor, represented by possible “freezing” of the reported data or drifting in its reading.

Once the failure of a single sensor is identified, step 50, the flight parameters that are consolidated and transmitted, for example to the flight control system, are those related to the subgroup that excludes the failed sensor, thus rendering the failure isolation functionality effective.

From the foregoing, it is evident that the method according to the present disclosure represents a significant development with respect to that described in the literature and known in the state of the art.

Application of the described methodology allows the calculation of flight parameters through the use of sensors buried in the surface of the aircraft, giving the system characteristics of low contribution to the radar signature during flight, less exposure to the risk of bird impact during flight, and easier handling for operators during ground operations (less risks of damaging the sensors).

With regard to low radar signature aircraft, the main advantage of this methodology of calculation of the flight parameters is represented by the use of mathematical models that enable easier validation of the entire process, with positive repercussions in terms of traceability and verification in a possible certification procedure.

Finally, it is clear that modifications and variants can be made to the disclosure set forth herein without departing from the scope of the present disclosure, as defined in the appended claims.

1. A method for calculation and consolidation of a first plurality of flight parameters of an aircraft (1) including a second plurality, equal to or greater than said first plurality, of pressure sensors (S₁-S_{N}) arranged at respective locations (i₁-i_{N}) on the aircraft, each pressure sensor being configured to provide a transduced pressure value (X₁-X_{N}) on the basis of a respective detected static pressure value, the method comprising the step of acquiring (10) said transduced pressure values (X₁-X_{N}) from the pressure sensors, and being characterized by further comprising the steps of:
defining (20) a system of equations by associating with each transduced pressure value (X₁-X_{N}) a respective non-linear mathematical model that is a function of said flight parameters and which defines a mathematical relationship between each transduced pressure value and the aerodynamic behaviour of the aircraft (1) at the location (i₁-i_{N}) of the pressure sensor (S₁-S_{N}) that has generated this transduced pressure value;
iteratively solving (20) said system of equations, obtaining a current value of each of said flight parameters at each respective location (i₁-i_{N});
calculating (30), for each respective location (i₁-i_{N}), a respective intermediate pressure value (Y₁-Y_{N}) by applying the current values of said flight parameters calculated for the respective location (i₁-i_{N}) to each mathematical model;
comparing (30, 40) each transduced pressure value (X₁-X_{N}) with the respective intermediate pressure value (Y₁-Y_{N}), obtaining a result value; and
detecting (40) an operation state of said pressure sensors on the basis of said result value.

2. The method according to claim 1, wherein the step of iteratively solving said system of equations comprises solving the system of equations using the Newton-Raphson Method.

3. The method according to claim 1, wherein said flight parameters comprise an angle of attack, an angle of sideslip, a flight Mach number and a flight static pressure, said non-linear mathematical model being defined by:
$${Ps}_{∞} + Cp ( AOA , AOS , Mach ) * \frac{1}{2} γ \cdot {Ps}_{∞} {Mach}^{2}$$
where AOA represents the angle of attack; AOS represents the angle of sideslip; Mach represents the flight Mach number; Ps_{∞} represents the flight static pressure; γ is a constant comprised between 1.3 and 1.5; and Cp is a function of said flight parameters that represents a pressure coefficient related to a location (i₁-i_{N}) on said aircraft (1).

4. The method according to claim 3, wherein obtaining a value of the pressure coefficient Cp comprises:
a. setting a Mach value;
b. setting an angle of sideslip AOS value equal to approximately zero;
c. varying the angle of attack AOA value in predetermined steps, and, for each pair of AOS-AOA values, obtaining a value of the pressure coefficient Cp;
d. repeating step c, setting a non-zero angle of sideslip AOS value;
e. acquiring a value of Cp for each pair of AOS-AOA values, on the basis of an iteration of step d;
f. repeating steps b-e, setting a Mach value different from the value set at step a;
g. constructing, for each Mach value considered at steps a and f, an array (M₁-M_{P}) containing a plurality of values of the pressure coefficient Cp for each pair of AOS-AOA values considered.

5. The method according to claim 1, wherein iteratively solving (20) the system of equations, comprises:
starting from an initial condition that is the consolidated solution at the previous time of calculation;
linearizing the system of equations around the consolidated solution at the previous time of calculation;
solving said system of linear equations so as to obtain the current value of each of said flight parameters related to a location (i₁-i_{N}).

6. The method according to claim 1, wherein iteratively solving (20) said system of equations further comprises defining a plurality of tolerance thresholds (Th), said current value of the flight parameters being obtained when the variation of said parameters during said iterations is lower than said tolerance threshold.

7. The method according to claim 1, wherein the step of calculating (30) the plurality of intermediate pressure values (Y₁-Y_{N}) comprises, for each respective location (i₁-i_{N}), entering the current value of the flight parameters calculated in the mathematical model describing the aerodynamic behaviour of the aircraft (1); and solving said mathematical model.

8. The method according to claim 1, wherein the step of comparing (40) comprises performing a mathematical subtraction operation between each of the intermediate pressure values (Y₁-Y_{N}) and a respective transduced pressure value (X₁-X_{N}), obtaining the respective result value that represents the calculation error of the intermediate pressure values (Y₁-Y_{N}) with respect to the transduced pressure values (X₁-X_{N}).

9. The method according to claim 1, wherein the step of detecting (40) the operation state of said pressure sensors on the basis of said result value comprises performing statistical analysis on said result values.

10. The method according to claim 9, wherein said statistical analysis comprises:
defining a plurality of subgroups of pressure sensors different from each other, each subgroup comprising a number of sensors equal to the total number of pressure sensors minus one;
calculating, for each pressure sensor of each subgroup, the respective result value;
calculating, for each subgroup, a value of standard deviation of the obtained result values;
detecting, among the values of standard deviation calculated for each subgroup, the one having the lowest value and such that it differs from the other values of standard deviation by an amount greater than a predetermined threshold;
associating a state of failure with the pressure sensor missing in said subgroup to which the lowest value of standard deviation is associated and such that it differs from the other values of standard deviation by an amount greater than a predetermined threshold.

11. The method according to claim 10, further comprising the step of inhibiting the acquisition (10) of the transduced pressure value (X₁-X_{N}) from the pressure sensor to which the state of failure is associated.

12. A calculation and consolidation system of a first plurality of flight parameters of an aircraft (1) that includes a second plurality, equal to or greater than said first plurality, of pressure sensors (S₁-S_{N}) arranged in respective locations (i₁-i_{N}) on the aircraft, each pressure sensor being configured to provide a transduced pressure value (X₁-X_{N}) on the basis of a respective detected static pressure value, the system comprising processing means (5) which acquire (10) said transduced pressure values (X₁-X_{N}) from the pressure sensors,
characterized in that the processing means (5) are configured to:
define (20) a system of equations by associating with each transduced pressure value (X₁-X_{N}) a respective non-linear mathematical model that is a function of said flight parameters and which defines a mathematical relationship between each transduced pressure value and the aerodynamic behaviour of the aircraft (1) at the location (i₁-i_{N}) of the pressure sensor (S₁-S_{N}) that has generated this transduced pressure value;
iteratively solve (20) said system of equations, obtaining a current value of each of said flight parameters at each respective location (i₁-i_{N});
calculate (30), for each respective location (i₁-i_{N}), a respective intermediate pressure value (Y₁-Y_{N}) by applying the current values of said flight parameters calculated for the respective location (i₁-i_{N}) to each mathematical model;
compare (30, 40) each transduced pressure value (X₁-X_{N}) with the respective intermediate pressure value (Y₁-Y_{N}), obtaining a result value; and
detect (40) an operation state of said pressure sensors on the basis of said result value.

13. A computer program product loadable in processing means (5) and designed so that, when run, the processing means become configured to implement the method according to claim 1.
